(19) United States
(12) Patent Application Publication
(10) Pub. No.: US 2015/0022645 A1
(43) Pub. Date: Jan. 22, 2015

(54) Method and Apparatus for Providing a Display Position of a Display Object and for Displaying a Display Object in a Three-Dimensional Scene

(71) Applicant: Huawei Technologies Co., Ltd., Shenzhen (CN)

(72) Inventors: Imed Bouazizi, Munich (DE); Giovanni Cordara, Munich (DE); Lukasz Kondrad, Munich (DE)

(21) Appl. No.: 14/511,351

(22) Filed: Oct. 10, 2014

Related U.S. Application Data
(63) Continuation of application No. PCT/EP2012/056415, filed on Apr. 10, 2012.

(51) Int. Cl. H04N 13/04; H04N 13/00

(52) U.S. Cl. CPC H04N 13/0456; H04N 13/0497; H04N 13/007; H04N 13/0018
USPC 348/51

(57) ABSTRACT

A method for determining a display position of a display object to be displayed together with a three-dimensional (3D) scene is provided. The method comprising: providing a display distance of one or more displayable objects comprised in the 3D scene with respect to a display plane; and providing the display position comprising a display distance of the display object in dependence on the display distance of the one or more displayable objects in the 3D scene.

### CROSS-REFERENCE TO RELATED APPLICATIONS

This application is a continuation of International Application No. PCT/EP2012/056415, filed on Apr. 10, 2012, which is hereby incorporated by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates to the field of three-dimensional (3D) multimedia including stereoscopic 3D and multi-view 3D video and still images. In particular, the invention relates to signaling information to manipulate timed text and timed graphic plane position in a 3D coordinate system.

### BACKGROUND

Available media file format standards include International Organization for Standardization (ISO) base media file format (ISO/IEC 14496-12), Moving Pictures Expert Group Number 4 (MPEG-4) file format (ISO/IEC 14496-14, also known as the MP4 format), Advanced Video Coding (AVC) file format (ISO/IEC 14496-15), Third Generation Partnership Project (3GPP) file format (3GPP TS 26.244, also known as the 3GP format), and Digital Video Broadcasting (DVB) file format. The ISO file format is the base for derivation of all the above mentioned file formats (excluding the ISO file format itself). These file formats (including the ISO file format itself) are called the ISO family of file formats.

FIG. 8 shows a simplified file structure 800 according to the ISO base media file format. The basic building block in the ISO base media file format is called a box. Each box has a header and a payload. The box header indicates the type of the box and the size of the box in terms of bytes. A box may enclose other boxes, and the ISO file format specifies which box types are allowed within a box of a certain type. Furthermore, some boxes are mandatorily present in each file, while others are optional. Moreover, for some box types, it is allowed to have more than one box present in a file. It could be concluded that the ISO base media file format specifies a hierarchical structure of boxes.

According to ISO family of file formats, a file 800 consists of media data and metadata that are enclosed in separate boxes, the media data (mdat) box 801 and the movie (moov) box 803, respectively. For a file 800 to be operable, both of these boxes 801, 803 must be present. The movie box 803 may contain one or more tracks 805, 807, and each track resides in one track box. A track can be one of the following types: media, hint, timed metadata. A media track refers to samples formatted according to a media compression format (and its encapsulation to the ISO base media file format). A hint track refers to hint samples, containing cookbook instructions for constructing packets for transmission over an indicated communication protocol. The cookbook instructions may contain guidance for packet header construction and include packet payload construction. In the packet payload construction, data residing in other tracks or items may be referenced, i.e. it is indicated by a reference which piece of data in a particular track or item is instructed to be copied into a packet during the packet construction process. A timed metadata track refers to samples describing referred media and/or hint samples. For the presentation one media type, typically one media track, e.g. video track 805 or audio track 807, is selected. Samples of a track are implicitly associated with sample numbers that are incremented by 1 in the indicated decoding order of samples.

It is noted that the ISO base media file format does not limit a presentation to be contained in one file 800, but it may be contained in several files. One file 800 contains the metadata 803 for the whole presentation. This file 800 may also contain all the media data 801, whereupon the presentation is self-contained. The other files, if used, are not required to be formatted to ISO base media file format, are used to contain media data, and may also contain unused media data, or other information. The ISO base media file format concerns the structure of the presentation file only. The format of the media-data files is constrained to the ISO base media file format or its derivative formats only in that the media-data in the media files must be formatted as specified in the ISO base media file format or its derivative formats.

Third Generation Partnership Project Specification Group Service and Systems Aspects: Codec (3GPP SA4) has worked on timed text and timed graphics for 3GPP services which resulted in technical specification TS 26.245 for timed text and technical specification (TS) 26.430 for timed graphics. FIG. 9 shows an example illustration of text rendering position and composition defined by 3GPP Timed Text in a two-dimensional (2D) coordinate system. Both formats, timed text and timed graphics enable the placement of text 903 and graphics in a multimedia scene relative to a video element 905 displayed in a display area 907. 3GPP Timed Text and Timed Graphics are composited on top of the displayed video 905 and relative to the upper left corner 911 of the video 905. A region 903 is defined by giving the coordinates (tx, ty) 913 of the upper left corner 911 and the width/height 915, 917 of the region 903. The text box 901 is by default set in the region 903 unless over-ridden by a ‘tbox’ in the text sample. Then the box values are defined as the relative values 919, 921 from the top and left positions of the region 903.

Timed text and timed graphics may be downloaded using Hypertext Transfer Protocol (HTTP, Request for Comments (RFC) 2616), as part of a file format or it may be streamed over Real-time Transport Protocol (RTP, RFC 3550).

3GP file extension for storage of timed text is specified in technical specification 3GPP TS 26.245 and RTP payload format in the standard RFC 4396.

Timed graphics may be realized in one of two ways: Scalable Vector Graphics (SVG)-based timed graphics or simple timed graphics mode. In the SVG-based timed graphics, the layout and timing are controlled by the SVG scene. For the transport and storage timed graphics reuses Dynamic and Interactive Multimedia Scenes (DIMS, 3GPP TS 26.142), RTP payload format and the 3GP file format extensions. The Timed Graphics also reuses the Session Description Protocol (SDP) syntax and media type parameters defined for DIMS. In the simple timed graphics mode, a binary representation format is defined to enable simple embedding of graphics elements. Timed Graphic is transmitted in simple form using timed text RTP payload format (RFC 4396) and 3GP file format extension specified in 3GPP TS 26.430.

Depth perception is the visual ability to perceive the world in 3D and the distance of an object. Stereoscopic 3D video refers to a technique for creating the illusion of depth in a scene by presenting two offset images of the scene separately to the left and right eye of the viewer. Stereoscopic 3D video conveys the 3D perception of the scene by capturing the scene via two separate cameras, which results in objects of the scene being projected to different locations in the left and right images.

By capturing the scene via more than two separate cameras a multi-view 3D video is created. Depending on the chosen pair of the captured images, a different perspective (view) of the scene can be presented. Multi-view 3D video allows a viewer to interactively control the viewpoint. Multi-view 3D video can be seen as a multiplex of number of stereoscopic 3D videos representing the same scene from different perspectives.

The displacement of an object or a pixel from the left view to the right view is called disparity. The disparity is inversely proportional to the perceived depth of the presented video scene.

Stereoscopic 3D video can be encoded in frame compatible manner. At the encoder side a spatial packing of a stereo pair into a single frame is performed and the single frames are encoded. The output frames produced by the decoder contain constituent frames of a stereo pair. In a typical operation mode, the spatial resolutions of the original frames of each view and of the packaged single frame have the same resolution. In this case the encoder down-samples the two views of the stereoscopic video before the packing operation. The spatial packing may use a side-by-side, top-bottom, interleaved, or checkerboard formats. The encoder side indicates the used frame packing format by appropriate signaling information. For example, in case of H.264/AVC video coding the frame packing is signaled utilizing the supplemental enhancement information (SEI) messages, which are part of the stereoscopic 3D video bitstream. The decoder side decodes the frame conventionally, unpacks the two constituent frames from the output frames of the decoder, does up-sampling in order to revert the encoder side down-sampling process and render the constituent frames on the 3D display. In most commercial deployments only side-by-side or top-bottom frame packing arrangements are applied.

Multi-view 3D video can be encoded by using multi-view video coding: an example of such coding techniques is H.264/Multiview Video Coding (MVC) which was standardized as an extension to the H.264/AVC standard. Multi-view video contains a large amount of inter-view statistical dependencies, since all cameras capture the same scene from different viewpoints. A frame from a certain camera can be predicted not only from temporally related frames from the same camera, but also from the frames of neighboring cameras. Multi-view video coding employs combined temporal and inter-view prediction which is the key for efficient encoding.

Stereoscopic 3D video can also be seen as a multi-view 3D video where only one 3D view is available. Therefore, stereoscopic 3D video can also be encoded using multi-view coding technique.

With the introduction of stereoscopic 3D video support in 3GPP, the placement of timed text and timed graphics is more challenging. According to the current 3GPP specification the timed text box or the timed graphic box will be placed in the same position on both views of stereoscopic 3D video. This corresponds to zero disparity and as such the object will be placed on screen. However, simply overlaying the text or graphics element on top of the stereoscopic 3D video does not result in satisfactory results, as it may confuse the viewer by communicating contradicting depth clues. As an example, a timed text box which is placed at the image plane (i.e. disparity is equal 0), would over-paint objects in the scene with negative disparity (i.e. an object that is supposed to appear to the viewer in front of the screen) and consequently disrupt the composition of the stereoscopic 3D video scene.

Blu-ray® provides depth control technology, which is introduced to avoid interference between Stereoscopic 3D video, timed text, and timed graphic. Two presentation types for the various timed text and timed graphic formats with Stereoscopic 3D video are defined in the Blu-ray® specifications. These are: a) one plane plus offset presentation type and b) stereoscopic presentation type.

FIG. 10A shows an example illustration of a plane overlay model for one plane plus offset presentation type defined by Blu-ray® where the 3D display surface 1001 forms the one plane and the 3D subtitle box 1003a and the 3D menu box 1005a are flat boxes and their positions 1007 and 1009 with respect to the 3D display 1001 are defined by a so-called “offset value”, which is related to the disparity.

In the one plane plus offset presentation type defined by Blu-ray® a user can see flat objects 1003a, 1005a at the distances 1007 and 1009 from screen 1001, which are defined by the signaled offset value. When text in the text box 1003a is expected to be presented between screen 1001 and user, right shifted by the offset value text box is overlaid onto the left view of stereoscopic 3D video, and the left shifted by the offset value text box is overlaid onto the right view of stereoscopic 3D video. The offset metadata is transported in an SEI message of the first picture of each group of pictures (GOP) of H.264/MVC dependent (second) view video stream. Offset metadata includes plural offset sequences, and each graphic type is associated with one of the offset sequences by an offset sequence identifier (id).

In stereoscopic presentation type defined by Blu-ray® timed graphic contains two pre-defined independent boxes corresponding to two views of the stereoscopic 3D video. One of which is overlaid onto the left view of stereoscopic 3D video, and the other of which is overlaid onto the right view of stereoscopic 3D video. Consequently, the user can see a 3D object positioned in the presented scene. Again, the distance of the graphic box is defined by the signaled offset value.

In the Blu-ray® solution the position of the text box or the graphic box is defined by the signaled offset value regardless of the presentation type used. FIG. 10B shows an example illustration of a plane overlay model for the stereoscopic presentation type defined by Blu-ray® where the 3D video screen 1001 forms the one plane and the 3D subtitle box 1003b and the 3D menu box 1005b are 3D boxes and their positions 1007 and 1009 with respect to the 3D video screen 1001 are defined by the signaled offset value.

### SUMMARY

An object of aspects of the invention and implementations thereof is to provide a concept for providing a display position of a display object, e.g. timed text or timed graphic, in a 3D scene that is more flexible.

A further object of aspects of the invention and implementations thereof is to provide a concept for providing a display position of a display object, e.g. timed text or timed graphic, that is independent or at least less dependent with respect to the display characteristics (screen size, resolution, etc.) of the target device displaying the 3D scene, and/or with respect to viewing conditions like the viewing distance (i.e. the distance between the viewer and the display screen).

A further object of aspects of the invention and implementations thereof is to provide a concept for providing an appropriate placement of a display object, e.g. a timed text box or a timed graphics box, taking depth into account.

One or all of these objects are achieved by the features of the independent claims. Further implementation forms are apparent from the dependent claims, the description and the figures.

The invention is based on the finding that by providing the position of the timed text or the timed graphic box based on the Z value, that is the distance from the display surface, allows to calculate correct disparities based on the hardware characteristic and user viewing distance thereby providing independence with respect to target devices and viewing conditions.

Techniques are available, which allow to create the second view of stereoscopic 3D video or any view of multi-view 3D video based on the Z value, not requiring disparity calculation. Consequently, timed text and timed graphic box have fixed positions from the display surface regardless of the hardware characteristic and viewing distance.

The 3D video concept also provides more freedom in positioning of timed text box and timed graphic box by assigning different position information, the so called Z value to different regions of the boxes. In consequence, the timed text box and timed graphic box are not limited to be positioned in parallel to the display surface.

Due to the use of position information the timed text box and timed graphic box can be mapped to more than two views through transformation operation. Consequently, the concept presented here can be applied to 3D scenes with more than two views (e.g. multi-view 3D video) and as such is not limited to 3D scenes with only two views as for example stereoscopic 3D video.

The signaling can be used to maintain a pre-defined depth of display objects, e.g. timed text and timed graphic planes, regardless of the display hardware characteristic and viewing distance.

In order to describe the invention in detail, the following terms, abbreviations and notations will be used:

2D: two-dimensional.

3D: three-dimensional.

AVC: Advanced Video Coding, defines the AVC file format.

MPEG-4: Moving Pictures Expert Group No. 4, defines a method for compressing audio and visual (AV) digital data, also known as the MP4 format.

3GPP: Third Generation Partnership Project, defines the 3GPP file format, also known as 3GP file format.

DVB: Digital Video Broadcasting, defines the DVB file format.

ISO: International Standardization Organization. The ISO file format specifies a hierarchical structure of boxes.

mdat: media data, data describing one or more tracks of a video or audio file.

moov: movie, video and/or audio frames of a video or audio file.

Timed text: refers to the presentation of text media in synchrony with other media, such as audio and video. Typical applications of timed text are the real time subtitling of foreign-language movies, captioning for people having hearing impairments, scrolling news items or teleprompter applications. Timed text for MPEG-4 movies and cellphone media is specified in MPEG-4 Part 17 Timed Text, and its Multipurpose Internet Mail Extensions (MIME) type (internet media type) is specified by RFC 3839 and by 3GPP 26.245.

Timed Graphics: refers to the presentation of graphics media in synchrony with other media, such as audio and video. Timed Graphics is specified by 3GPP TS 26.430.

HTTP: Hypertext Transfer Protocol, defined by RFC 2616.

RTP: Real-time Transport Protocol, defined by RFC 3550.

SVG: Scalable Vector Graphics, one method for realizing timed graphics.

DIMS: Dynamic and Interactive Multimedia Scenes, defined by 3GPP TS 26.142, is a protocol used by timed graphics for transport and storage.

SDP: Session Description Protocol, defined by RFC 4566, is a format for describing streaming media initialization parameters, used by timed graphics.

SEI: Supplemental Enhancement Information, is a protocol for signaling the frame packing.

GOP: Group Of Pictures, multiple pictures of a video stream.

The term “displayable object” is used to refer to 2D or 3D objects already comprised in a 3D scene to distinguish such objects from an additional “display object” to be added or displayed together with or in the same 3D scene. The term “displayable” shall also indicate that one or more of the already existing displayable objects may be partly or in total overlaid by the “display object” when displayed together with the display object.

According to a first aspect, the invention relates to a method for determining a display position of a display object to be displayed in or together with a 3D scene, the method comprising: providing a display distance of one or more displayable objects comprised in the 3D scene with respect to a display plane; and providing the display position comprising a display distance of the display object in dependence on the display distance of the one or more displayable objects in the 3D scene.

In a first possible implementation form of the method according to the first aspect the display object is a graphic object, in particular at least one timed graphic box or one timed text box.

In a second possible implementation form of the method according to the first aspect as such or according to the first implementation form of the first aspect, the display plane is a plane determined by a display surface of a device for displaying the 3D scene.

In a third possible implementation form of the method according to the first aspect as such or according to any of the preceding implementation forms of the first aspect, the step of providing the display distance of the one or more displayable objects comprises determining a depth map and calculating the display distance (znear) from the depth map.

In a fourth possible implementation form of the method according to the first aspect as such or according to any of the preceding implementation forms of the first aspect, wherein the step of providing the display position comprises: providing the display distance of the display object such that the display object is perceived to be as close or closer to a viewer than any other displayable object of the 3D scene when displayed together with the 3D scene.

In a fifth possible implementation form of the method according to the first aspect as such or according to any of the preceding implementation forms of the first aspect, the step of providing the display position of the display object comprises: determining the display distance of the display position of the display object as being greater than or equal to the display distance of the displayable object which has the closest distance to the viewer among the plurality of displayable objects in the 3D scene; or determining the display distance of the display position of the display object as being a difference, in particular a percentage of a difference, between the display distance of the displayable object which has the farthest distance to the viewer among the plurality of displayable objects in the 3D scene and another displayable object which has the closest distance to the viewer among the displayable objects in the same 3D scene; or determining the display distance of the display position of the display object as being at least one corner display position of the display object, the corner display position being greater than or equal to the display distance, in particular the display distance of the displayable object which has the closest distance to the viewer among the plurality of displayable objects in the 3D scene.

In a sixth possible implementation form of the method according to the first aspect as such or according to any of the preceding implementation forms of the first aspect, the step of providing the display position comprises: providing the display distance of the display object such that the display distance (zbox) of the display object is equal to or greater than the display distance of any other displayable object positioned on the same side of the display plane as the display object.

In a seventh possible implementation form of the method according to the first aspect as such or according to any of the preceding implementation forms of the first aspect, the method comprises transmitting the display position of the display object together with the display object over a communication network.

In an eighth possible implementation form of the method according to the first aspect as such or according to any of the preceding implementation forms of the first aspect, the method comprises storing the display position of the display object together with the display object.

In a ninth possible implementation form of the method according to the first aspect as such or according to any of the preceding implementation forms of the first aspect, the display position of the display object is determined for a certain 3D scene, and wherein another display position of the display object is determined for another 3D scene.

In a tenth possible implementation form of the method according to the first aspect as such or according to any of the preceding implementation forms of the first aspect, the 3D scene is a 3D still image, the displayable objects are image objects and the display object is a graphic box or a text box.

In an eleventh possible implementation form of the method according to the first aspect as such or according to any of the first to ninth implementation forms of the first aspect, the 3D scene is a 3D video image, the displayable objects are video objects and the display object is a timed graphic box or a timed text box, wherein the 3D video image is one of a plurality of 3D video images comprised in a 3D video sequence.

In a twelfth possible implementation form of the method according to the first aspect as such or according to any of the preceding implementation forms of the first aspect, the display object and/or the displayable objects are 2D or 3D objects.

According to a second aspect, the invention relates to a method for displaying a display object in or together with a 3D scene, comprising one or more displayable objects, the method comprising: receiving the 3D scene; receiving a display position of the display object comprising a display distance (zbox) of the display object with respect to a display plane; and displaying the display object at the received display position when displaying the 3D scene.

According to a third aspect, the invention relates to an apparatus being configured to determine a display position of a display object to be displayed in or together with a 3D scene, the apparatus comprising a processor, the processor being configured to provide a display distance of one or more displayable objects comprised in the 3D scene with respect to a display plane; and to provide the display position comprising a display distance of the display object in dependence on the display distance of the one or more displayable objects in the 3D scene.

In a first possible implementation form of the apparatus according to the third aspect, the processor comprises a first provider for providing the display distance of one or more displayable objects with respect to the display plane, and a second provider for providing the display position of the display object in dependence on the display distance of the one or more displayable objects in the same 3D scene.

According to a fourth aspect, the invention relates to an apparatus for displaying a display object to be displayed in or together with a 3D scene, comprising one or more displayable objects, the apparatus comprising: an interface for receiving the 3D scene, comprising the one or more displayable objects, and for receiving the display object, and for receiving a display position of the display object comprising a display distance of the display object with respect to a display plane; and a display for displaying the display object at the received display position when displaying the 3D scene comprising the one or more displayable objects.

According to a fifth aspect, the invention relates to a computer program with a program code for performing the method according to the first aspect as such or according to any of the preceding implementation forms of the first aspect or the method according to the second aspect when the program code is executed on a computer.

The methods described herein may be implemented as software in a Digital Signal Processor (DSP), in a micro-controller or in any other side-processor or as hardware circuit within an application specific integrated circuit (ASIC).

The invention can be implemented in digital electronic circuitry, or in computer hardware, firmware, software, or in combinations thereof.

### BRIEF DESCRIPTION OF THE DRAWINGS

Further embodiments of the invention will be described with respect to the following figures, in which:

FIG. 1 shows a schematic diagram of method for determining a display position of a display object in a 3D scene according to an implementation form;

FIG. 2 shows a schematic diagram of a plane overlay model usable for determining a display position of a display object in a 3D scene according to an implementation form;

FIG. 3 shows a schematic diagram of method for determining a display position of a display object in a 3D scene according to an implementation form;

FIG. 4 shows a schematic diagram of a method for displaying a display object in a 3D scene according to an implementation form;

FIG. 5 shows a schematic diagram of a method for displaying a display object in a 3D scene according to an implementation form;

FIG. 6 shows a block diagram of an apparatus for determining a display position of a display object in a 3D scene according to an implementation form;

FIG. 7 shows a block diagram of an apparatus for displaying a display object in a 3D scene according to an implementation form;

FIG. 8 shows a block diagram illustrating the simplified structure of an ISO file according to the ISO base media file format;

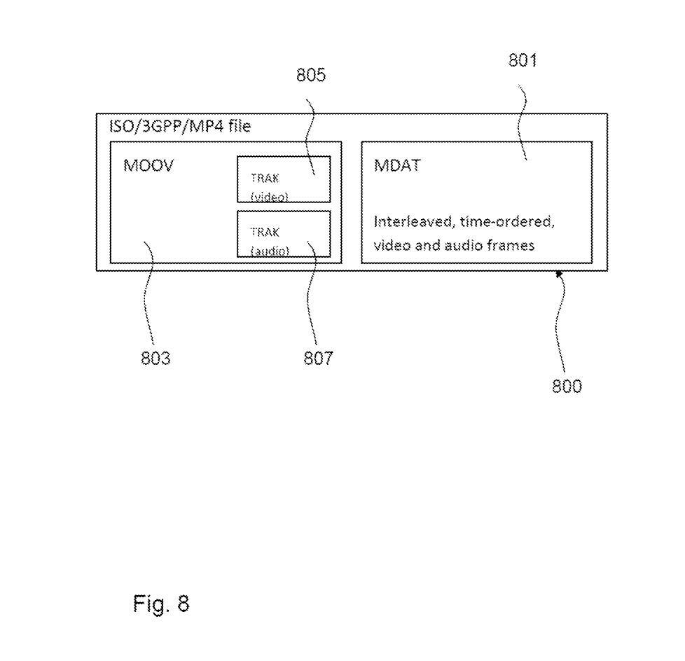

FIG. 9 shows a schematic diagram of text rendering position and composition defined by 3GPP Timed Text in 2D coordination system;

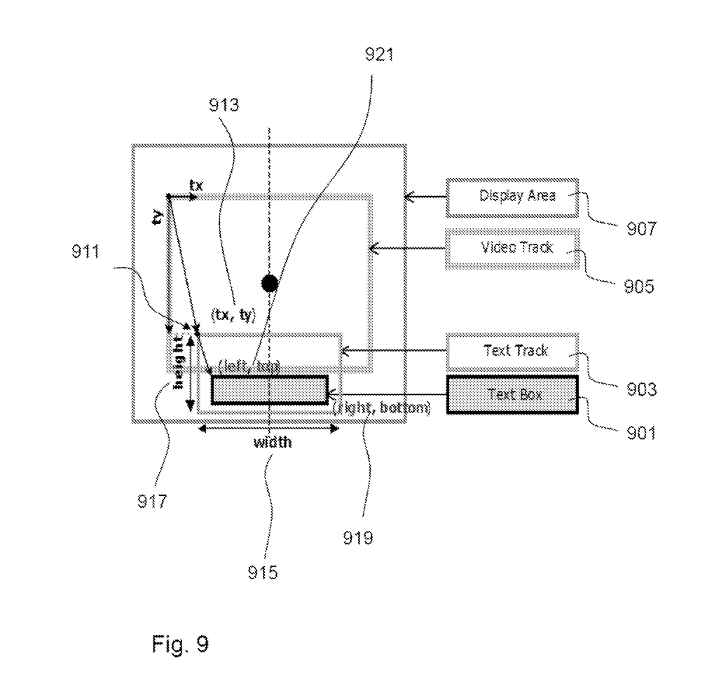

FIG. 10A shows a schematic diagram of a plane overlay model for one plane plus offset presentation type defined by Blu-ray®; and

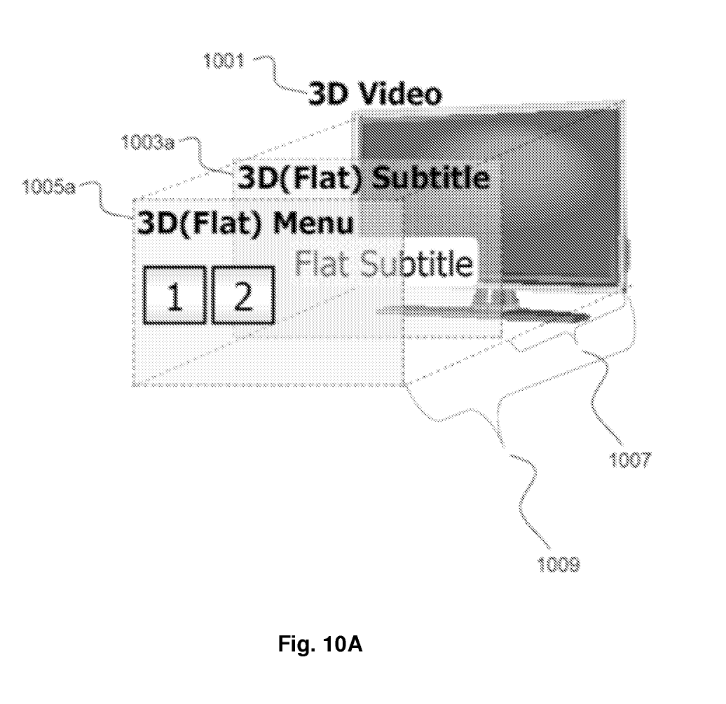

FIG. 10B shows another schematic diagram of a plane overlay model for stereoscopic presentation type defined by Blu-ray®.

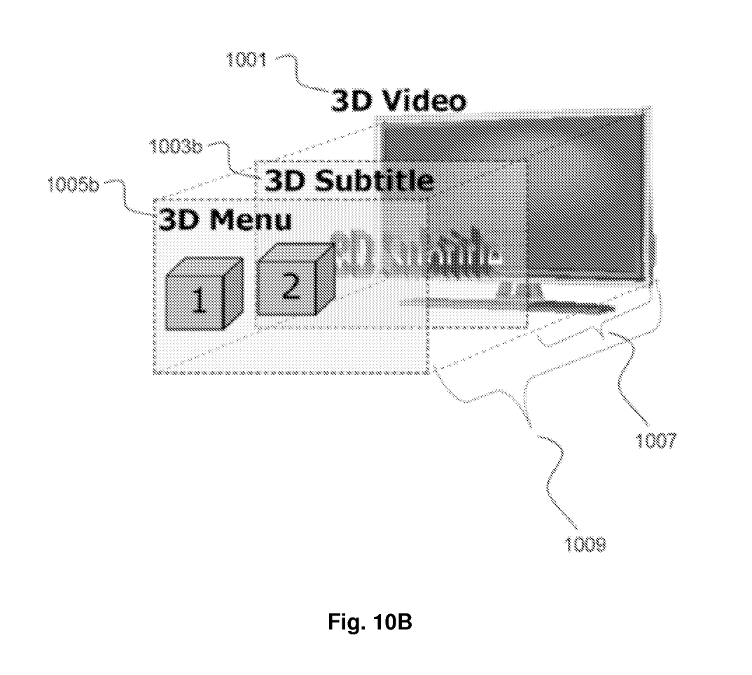

### DETAILED DESCRIPTION

Before describing details of embodiments of the invention, further findings with regard to the prior art are described for a better understanding of the invention. As mentioned before, the displacement of an object or a pixel from the left view to the right view is called disparity. The disparity is proportional to the perceived depth of the presented video scene and is signaled and used to define the 3D impression.

The depth perceived by the viewer, however, depends also on the display characteristic (screen size, pixel density), viewing distance (distance between a viewer and a screen on which the images are displayed), and the viewer predisposition (inter-pupil distance of the viewer). The relation between the depth perceived by a viewer, disparity, and display characteristic (i.e. display size and display resolution) can be calculated as follows:

$$D = \frac{V}{\frac{I}{{s}_{D} * d} - 1} , \qquad ( 1 )$$

where D is perceived 3D depth, V is viewing distance, I is the inter-pupil distance of the viewer, s_{D} is the display pixel pitch of the screen (in horizontal dimension), and d is the disparity.

Based on equation (1) it can be seen that in Blu-ray® solutions the final perceived depth, i.e. distance 1007, 1009 of the 3D objects from the 3D display 1001, does not only depend on the offset value, which is equal to half of the disparity value, but also on the display 1001 characteristic (screen size and resolution) and viewing distance. However, the offset value provided in Blu-ray® solution must be set in an advance without full knowledge what the target device and viewing conditions are. Due to this the perceived depth varies from device to device as well as it is dependent on the viewing conditions. Moreover, the Blu-ray® solution limits the degree of freedom in positioning of the text box 1003b or the graphic box 1005b to be 2D surfaces parallel to the screen 1001. As a result, it is impossible to blend the graphic or text into stereoscopic 3D video. Finally, the Blu-ray® solution is limited to stereoscopic 3D video and does not address how to place the text box or graphic box when multi-view 3D video is considered.

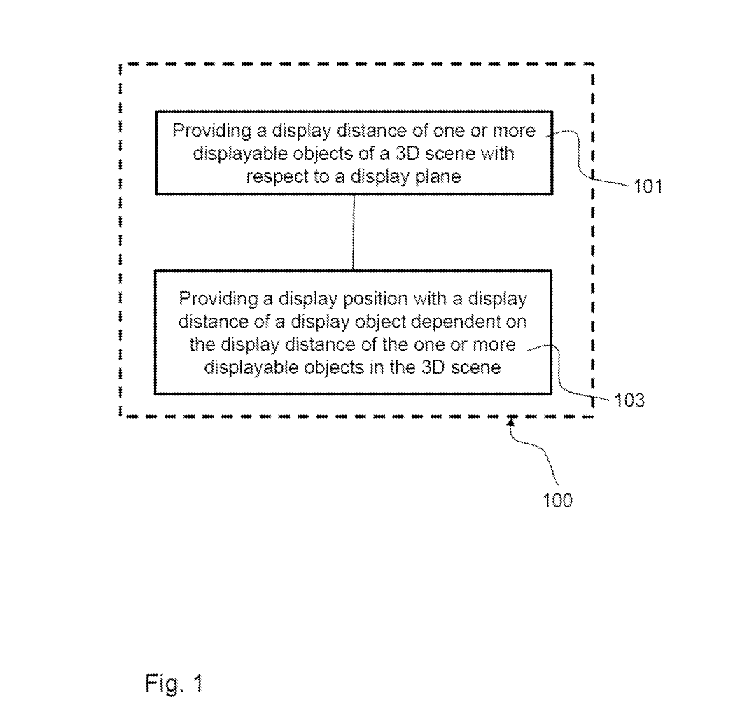

FIG. 1 shows a schematic diagram of method 100 for determining a display position of a display object in a 3D scene according to an implementation form. The method 100 is for determining the display position x, y, z of a display object to be displayed together with a 3D scene in accordance with one or more displayable objects in the 3D scene. The method 100 comprises: providing 101 a display distance of the one or more displayable objects in the 3D scene with respect to a display plane; and providing 103 the display position x, y, z comprising a display distance of the display object in dependence on the display distance of the one or more displayable objects in the same 3D scene.

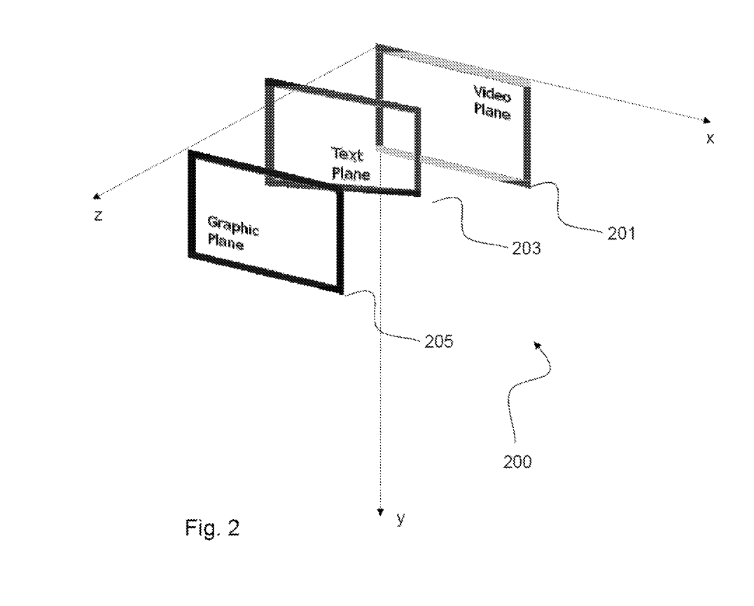

The display position is a position in a 3D coordinate system, where x denotes a position on x-axis, y denotes a position on y-axis and z denotes a position on z-axis. A possible coordinate system will be explained with regard to FIG. 2. The display object and the displayable objects are objects which are to be displayed on a display surface of a device. The display device can be, for example, a 3D capable television (TV)-set or monitor with a corresponding display or screen, or a 3D mobile terminal or any other portable device with a corresponding display or screen.

The display object can be a graphic object. In implementations for still images, the 3D scene can be a 3D still image, the displayable objects can be 2D or 3D image objects and the display object can be a 2D or 3D graphic box or a 2D or 3D text box. In implementations for videos, the 3D scene can be a 3D video image, the displayable objects can be 2D or 3D video objects and the display object can be a 2D or 3D timed graphic box or a timed text box.

Timed text refers to the presentation of text media in synchrony with other media, such as audio and video. Typical applications of timed text are the real time subtitling of foreign-language movies, captioning for people having hearing impairments, scrolling news items or teleprompter applications. Timed text for MPEG-4 movies and cellphone media is specified in MPEG-4 Part 17 Timed Text, and its MIME type (internet media type) is specified by RFC 3839 and by 3GPP 26.245.

Timed Graphics refers to the presentation of graphics media in synchrony with other media, such as audio and video. Timed Graphics is specified by 3GPP TS 26.430. The video object is an object shown in the movie, for example a person, a thing such as a car, a flower, a house, a ball or anything else. The video object is moving or has a fixed position. The 3D video sequence comprises a multiple of video objects. The 3D scene may comprise one or more video objects, timed text object, timed graphics object, or combinations thereof.

The display plane is a reference plane where the display object is displayed, e.g. a screen, a monitor, a telescreen or any other kind of display. The display distance is the distance of the display object to the display plane with respect to the z-axis of the coordinate system. As the display object has a distance from the display plane thereby producing a 3D effect to the viewer. In an implementation form, the origin of the coordinate system is located on the top left corner of the display surface.

FIG. 2 shows a schematic diagram of a plane overlay model 200 usable for determining a display position of display object in a 3D coordinate system according to an implementation form.

The display position of a displayable object or of the display object is defined in a 3D coordinate system, where x denotes a position on the x-axis, y denotes a position on the y-axis and z denotes a position on the z-axis as shown in FIG. 2. The display plane is defined by the x-axis and the y-axis and forms a reference plane with respect to which the display distance of a displayable object or of the display object in z-direction is defined. The display plane can be defined to correspond to the physical display surface of a device for displaying the 3D scene or, for example, any other plane parallel to the physical display surface of a device for displaying the 3D scene.

In the coordinate system shown in FIG. 2, the origin of the coordinate system is in the top left corner of the display surface. The x-axis is parallel to the display surface with a direction towards the top right corner of the display surface. The y-axis is parallel to the display surface with a direction to the bottom left corner of the display surface. The z-axis is perpendicular to the display surface with a direction towards the viewer for positive z-values, i.e. displayable or display objects with a z-value 0 are positioned on the display plane, displayable or display objects with a z-value greater than 0 are positioned or displayed before the display plane and the greater the z-value the nearer the displayable or display objects are perceived to be positioned or displayed to the viewer. Displayable or display objects with a z-value smaller than 0 (negative z-values) are positioned or displayed behind the display plane and the smaller the z-value the farther the displayable or display object are perceived to be positioned or displayed to the viewer.

The plane overlay model 200 in FIG. 2 overlays a graphic plane 205, e.g. a timed graphic box, and a text plane 203, e.g. a timed text box, over a video plane 201.

The timed text box 203 or the timed graphic box 205 in which the text or graphics element is to be placed is positioned correctly in the 3D scene.

Although FIG. 2 refers to a 3D video implementation with a video plane, the same plane overlay model 200 can also be applied for 3D still images, the reference sign 201 then referring to an image plane, or in general, to 3D scenes of any kind. The reference sign 201 then referring to any display plane.

The coordinate system as shown in FIG. 2 is only one possible coordinate system, other coordinate systems, in particular other cartesian coordinate systems with different definitions of the origin and the direction of the axis for positive values can be used to implement embodiments of the invention.

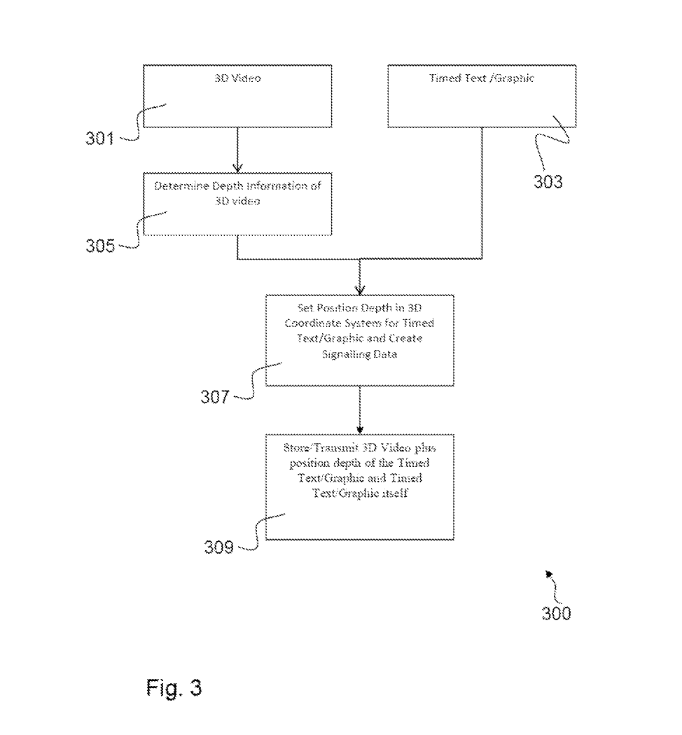

FIG. 3 shows a schematic diagram of method 300 for determining a display position of a display object in a 3D scene according to an implementation form. Exemplarily, FIG. 3 shows a schematic diagram of method 300 for determining a display position of a timed text and/or timed graphic object in a 3D video image or 3D video scene.

The method 300 is for determining the display position x, y, z of a display object 303, e.g. a timed text object or a timed graphic object to be displayed in the 3D scene 301 comprising a plurality of displayable objects. The method 300 comprises: providing a 3D scene, e.g. 3D video 301, and providing a timed text and or timed graphic object 303. The method 300 comprises further: determining 305 a depth information of the 3D scene, e.g. 3D video 301, setting 307 position of the timed text and or timed graphic object 303 in the 3D coordinate system for timed text and/or timed graphic and creating the corresponding signaling data. The method 300 further comprises: storing and or transmitting 309 3D scene plus position of the timed text and or timed graphic and the timed text and or timed graphic itself.

Although FIG. 3 refers to a 3D video implementation with a 3D video as 3D scene and a timed text and or a timed graphics object as display object, the same method can be applied for 3D still images, the reference sign 301 then referring to a 3D still image, the reference signs 303 then referring to a text and or a graphics object, step 305 to determining depth information of the 3D still image, step 307 to setting the position of the text and or graphic object 303 in the 3D coordinate system, and step 309 to storing and or transmitting the 3D still image plus the position of the text and or graphic and the text and or graphic itself.

In other words, FIG. 3 depicts a specific video implementation, whereas the same method can also be applied for a 3D scene in general, the reference sign 301 then referring to the 3D scene, the reference signs 303 then referring to the display object, step 305 to determining depth information of the 3D scene, step 307 to setting the position of the display object 303 in the 3D coordinate system, and step 309 to storing and or transmitting the 3D scene plus the position of the display object and the display object itself.

The step of determining 305 depth information of the 3D scene, e.g. 3D video 301, may correspond to the step of providing 101 a display distance of one or more displayable objects with respect to a display plane as described with respect to FIG. 1.

The step of setting 307 position depth in 3D coordinate system for timed text and or timed graphic and creating signaling data may correspond to the step of providing 103 the display position x, y, z of the display object in dependence on the display distance of the one or more displayable objects in the 3D scene as described with respect to FIG. 1.

In a first implementation form, 3D placement of a timed text and timed graphics according to step 307 is as follows. Zₙₑₐᵣ, which is the display distance of the display position of a displayable object closest to the viewer of a 3D scene, is extracted or estimated. Z_{box}, which is the display distance of the display position of the timed text object or timed graphic object (or of the display object in general) in z dimension, is set to be closer to the viewer than the closest displayable object of 3D scene, e.g. 3D video 301, i.e. Z_{box}>Zₙₑₐᵣ. Z_{box} and Zₙₑₐᵣ are coordinates on the z-axis of the coordinate system as depicted in FIG. 2.

In an embodiment of the first implementation form, Zₙₑₐᵣ is determined as follows: first find the same features in the left and right views of the 3D video, a process known as correspondence. The output of this step is a disparity map, where the disparities are the differences in x-coordinates on the image planes of the same feature in the left and right views: x₁−xᵣ. Where x₁ and xᵣ are the positions of the feature in x-coordinates in the left view and the right view, respectively. Using the geometric arrangement information of the cameras that were used to capture the 3D video, the disparity map is turned into distances, i.e. a depth map. Alternatively, knowing the target screen size and viewing distance the 3D video was created, a depth map is calculated by using the equation (1) as described above. The Zₙₑₐᵣ value is extracted from the depth map data. Zₙₑₐᵣ is a coordinate on the z-axis and x₁ and xᵣ are coordinates on the x-axis of the coordinate system as depicted in FIG. 2.

In an embodiment of the first implementation form, a file format for 3D video contains information of the maximum disparity between the spatially adjacent views. In “ISO/IEC 14496-15 Information technology—Coding of audio-visual objects—Part 15: ‘Advanced Video Coding (AVC) file format’, June 2010” a box (‘vwdi’) to contain such information is specified. The signalled disparity is used to extract the maximum depth in a given scene.

In a second implementation form 3D placement of a timed text object and or timed graphics object (or of the display object in general) according to step 307 is as follows: Zₙₑₐᵣ, which is the display distance of the display position of a closest displayable object to the viewer of a 3D scene, e.g. 3D video 301, is extracted or estimated. Z_{f}, which is the display distance of the display position of a farthest displayable object to the viewer of a 3D scene, e.g. 3D video 301, is extracted or estimated. Z_{box}, which is the display distance of the display position of the timed text object or timed graphic object (or of the display object in general) in z dimension, is represented by Z_{percent} which is a percentage of the Z_{far}−Zₙₑₐᵣ distance of 3D scene, e.g. 3D video 301. Zₙₑₐᵣ, Z_{box} and Z_{far} are coordinates on the z-axis of the coordinate system as depicted in FIG. 2.

In a third implementation form, 3D placement of a timed text object and timed graphics object (or of the display object in general) according to step 307 is as follows: each corner of the box (Z_{corner}_{_{—}}ₜₒₚ_{_{—}}_{left}, Z_{corner}_{_{—}}ₜₒₚ_{_{—}}_{right}, Z_{corner}_{_{—}}_{bottom}_{_{—}}_{left}, Z_{corner}_{_{—}}_{bottom}_{_{—}}_{right}) is assigned a separate Z value, where each corner Z_{corner}>Zₙₑₐᵣ where Zₙₑₐᵣ is estimated only for the region of the given corner. Z_{corner}_{_{—}}ₜₒₚ_{_{—}}_{left}, Z_{corner}_{_{—}}ₜₒₚ_{_{—}}_{right}, Z_{corner}_{_{—}}_{bottom}_{_{—}}_{left}, and Z_{corner}_{_{—}}_{bottom}_{_{—}}_{right} are coordinates on the z-axis of the coordinate system as depicted in FIG. 2.

In an embodiment of the third implementation form, the Z_{corner} values of the timed text box, as an implementation of a timed text object or a display object are signaled in the 3GPP file format by specifying a new class called 3DRecord and a new text style box ‘3dtt’ as follows:

aligned(8) class 3DRecord {

| | |
|---|---|
| unsigned int(16) | startChar; |
| unsigned int(16) | endChar; |
| unsigned int(32) [3] | top-left; |
| unsigned int(32) [3] | top-right; |
| unsigned int(32) [3] | bottom-left; |
| unsigned int(32) [3] | bottom-right; |

},

where startChar is a character offset of the beginning of this style run (always 0 in a sample description), endChar is the first character offset to which this style does not apply (always 0 in a sample description); and shall be greater than or equal to startChar. All characters, including line-break characters and any other non-printing characters, are included in the character counts, top-left, top-right, bottom-left and bottom-right contain (x,y,z) coordinates of a corner; a positive value of z indicates a position in front of a screen, i.e. closer to a viewer and a negative value a position behind a screen, i.e. farther from a viewer;

and class TextStyleBox( ) extends TextSampleModifierBox (‘3dtt’) {

| | |
|---|---|
| unsigned int(16) | entry-count; |
| 3DRecord | text-styles[entry-count]; |

} ,

where ‘3dtt’ specifies the position of the text in 3D coordinates. It consists of a series of 3D records as defined above, preceded by a 16-bit count of the number of 3D records. Each record specifies the starting and ending character positions of the text to which it applies. The 3D records shall be ordered by starting character offset, and the starting offset of one 3D record shall be greater than or equal to the ending character offset of the preceding record; 3D records shall not overlap their character ranges.

In an embodiment of the third implementation form, placement of a timed text and or timed graphics box (or of the display object in general) according to step 307 is as follows: the Z_{corner} values of the timed graphic box (or of the display object in general) are signaled in the 3GPP file format by specifying a new text style box ‘3dtg’ as follows:

class TextStyleBox( ) extends SampleModifierBox (‘3dtg’) {

| | |
|---|---|
| unsigned int(32) [3] | top-left; |
| unsigned int(32) [3] | top-right; |
| unsigned int(32) [3] | bottom-left; |
| unsigned int(32) [3] | bottom-right; |

} ,

where top-left, top-right, bottom-left and bottom-right contain (x,y,z) coordinates of a corner. A positive value of z indicates a position in front of a screen, i.e. closer to a viewer and a negative value of z indicated a position behind a screen, i.e. farther from a viewer.

In a fourth implementation form, placement of a timed text object and or timed graphics object (or of the display object in general) according to step 307 is as follows: the flexible text box and or graphics box is based on signaling the position of one corner of the box (typically the upper left corner) (x,y,z) in the 3D space or 3D scene, the width and height of the box (width, height), in addition to rotation (alpha_x, alpha_y, alpha_z) and translation (trans_x, trans_y) operations. The terminal then calculates the position of all corners of the box in the 3D space by using the rotation matrix Rx*Ry*Rz, where:

Rx={1 0 0; 0 cos(alpha_x) sin(alpha_x); 0−sin(alpha_x) cos(alpha_x)},

Ry={cos(alpha_y) 0−sin(alpha_y); 0 1 0; sin(alpha_y) 0 cos(alpha_y)},

Rz={cos(alpha_z) sin(alpha_z) 0; −sin(alpha_z) cos(alpha_z) 0; 0 0 1}, and adding the translation vector (trans_x, trans_y, 0). To store and transmit such information new boxes and classes of ISO base media file format such as 3GP file format similarly as described in an embodiment of the third implementation are created.

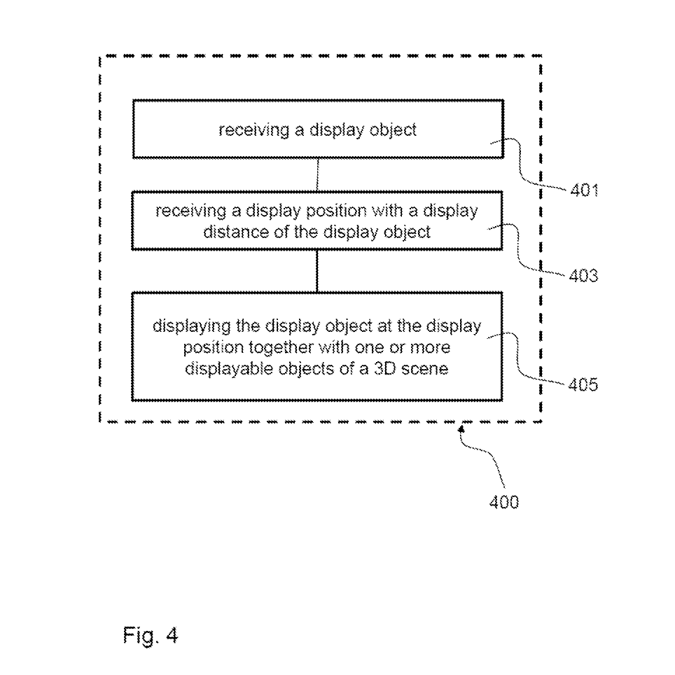

FIG. 4 shows a schematic diagram of a method 400 for displaying a display object together with a 3D scene according to an implementation form.

The method 400 is used for displaying a display object to be displayed at a display position in a 3D scene when displayed together with one or more displayable objects comprised in the 3D scene. The method 400 comprises: receiving the 3D scene comprising one or more displayable objects, receiving 401 the display object; receiving 403 a display position x, y, z with a display distance of the display object with regard to a display plane; and displaying 405 the display object at the received display position x, y, z together with one or more displayable objects of the 3D scene when displaying the 3D scene. The display object may correspond to the timed text object or timed graphics object 303 as described with respect to FIG. 3.

In the first to the fourth implementation form as described with regard to FIG. 3, the projection operation is performed to project the box onto the target views of 3D scene (e.g. the left and right view of stereoscopic 3D video). This projective transform is performed based on the following equation (or any of its variants, including coordinate system adjustments):

$${s}^{′} ( x , y ) = s ( cx + ( x - cx ) \frac{Vx}{Vx - z} , cy + ( y - cy ) \frac{Vy}{Vy - z} )$$

where vₓ and v_{y} represent the pixel sizes in horizontal and vertical directions multiplied by the viewing distance, cx and cy represent the coordinates of the center of projection.

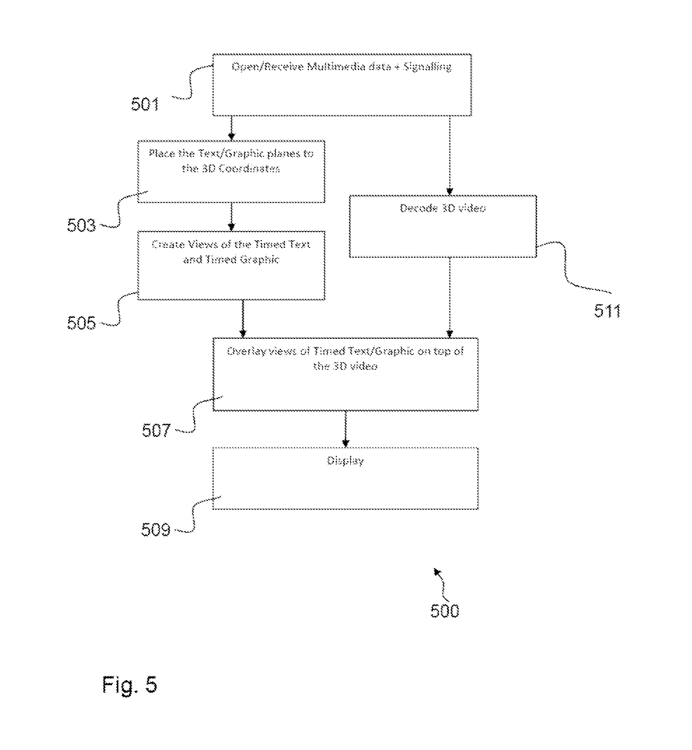

FIG. 5 shows a schematic diagram of a method 500 for displaying a display object in a 3D scene according to an implementation form. Exemplarily, FIG. 5 shows a schematic diagram of method 500 for displaying a timed text and or timed graphic object in a 3D video image or 3D video scene.

Although FIG. 5 refers to a 3D video implementation with a 3D video as 3D scene and a timed text and or a timed graphics object as display object, the same method can be applied for 3D still images and a text and or a graphics object, or in general to 3D scenes and display objects.

The method 500 is used for displaying a display object to be displayed at the received display position x, y, z in a 3D scene. The method 500 comprises: open/receiving 501 multimedia data and signaling data; placing 503 the timed text object and or timed graphics object to the 3D coordinates according to received display position x, y, z; creating 505 views of the timed text and timed graphic; decoding the 3D video 511; overlaying 507 views of timed text and or timed graphic on top of the decoded 3D video and displaying 509.

The step of open/receiving 501 multimedia data and signaling data may correspond to the step of receiving 401 the display object as described with respect to FIG. 4. The steps of placing 503 the display object to the 3D coordinates and creating 505 views of the display object may correspond to the step of receiving 403 the display position of the display object as described with respect to FIG. 4. The steps of overlaying 507 views of a timed text and or a timed graphic object on top of the 3D video and displaying 509 may correspond to the step of displaying 405 display object at the display position when displaying the one or more displayable objects of the 3D scene as described with respect to FIG. 4.

At the receiver or decoder side the signalling information is parsed according to step 501. Based on the signalling information the timed text object and or the timed graphic object are projected to the 3D coordinates' space according to step 503. In the next step 505, the timed text object and or the timed graphic object is projected to the views of 3D scene through transformation operation. The terminal then overlays the timed text views and or the timed graphic views over views of 3D scene according to step 507 which are displayed on a screen of the terminal according to step 509. The calculation of the coordinates of the timed text object and or the timed graphic object are illustrated by reference sign 503 and the creating the corresponding views of the timed text and timed graphic in the processing chain at the decoder side are illustrated by reference sign 505 in FIG. 5.

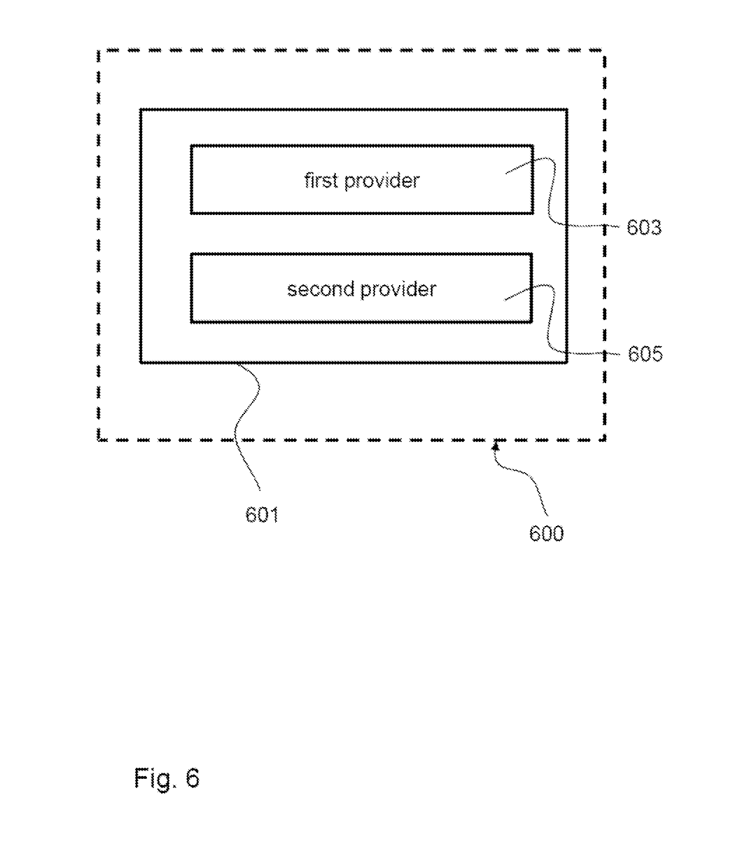

FIG. 6 shows a block diagram of an apparatus 600 according to an implementation form. The apparatus 600 is configured to determine a display position x, y, z of a display object, e.g. a display object 303 as described with respect to FIG. 3, to be displayed in a 3D scene, e.g. in front of a certain displayable object 301 as described with respect to FIG. 3, in a 3D scene comprising a plurality of displayable objects. The apparatus 600 comprises a processor 601 which is configured to provide a display distance z of a one or more displayable objects of the 3D scene with respect to a display plane; and to provide the display position x, y, z with the display distance z with regard to the display plane of the display object in dependence on the display distance z of the one or more displayable objects of the same 3D scene.

The processor 601 comprises a first provider 603 for providing the display distance z of one or more displayable objects of the 3D scene with respect to the display plane, and a second provider 605 for providing the display position x, y, z with the display distance z with regard to the display plane of the display object in dependence on the display distance z of the one or more displayable objects of the same 3D scene.

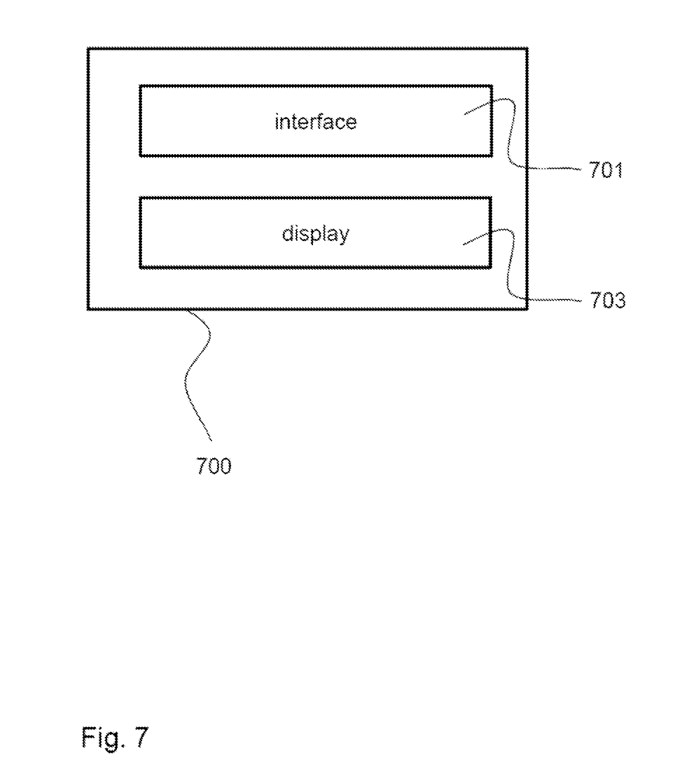

FIG. 7 shows a block diagram of an apparatus 700 according to an implementation form. The apparatus 700 is used for displaying a display object, e.g. a display object 303 as described with respect to FIG. 3, to be displayed in or together with a 3D scene, e.g. a 3D video 301, as described with respect to FIG. 3, comprising a plurality of displayable objects. The apparatus 700 comprises: an interface 701 for receiving the display object and for receiving a display position x, y, z of the display object comprising a distance, e.g. a constant distance, from a display plane; and a display 703 for displaying the display object at the received display position x, y, z when displaying one or more displayable objects of the 3D scene.

From the foregoing, it will be apparent to those skilled in the art that a variety of methods, systems, computer programs on recording media, and the like, are provided.

The present disclosure also supports a computer program product including computer executable code or computer executable instructions that, when executed, causes at least one computer to execute the performing and computing steps described herein.

The present disclosure also supports a system configured to execute the performing and computing steps described herein.

Many alternatives, modifications, and variations will be apparent to those skilled in the art in light of the above teachings. Of course, those skilled in the art readily recognize that there are numerous applications of the invention beyond those described herein. While the present invention has been described with reference to one or more particular embodiments, those skilled in the art recognize that many changes may be made thereto without departing from the spirit and scope of the present invention. It is therefore to be understood that within the scope of the appended claims and their equivalents, the inventions may be practiced otherwise than as specifically described herein.

What is claimed is:

1. A method for determining a display position of a display object to be displayed together with a three-dimensional (3D) scene, the method comprising:
providing a display distance of one or more displayable objects comprised in the 3D scene with respect to a display plane; and
providing the display position comprising a display distance of the display object in dependence on the display distance of the one or more displayable objects in the 3D scene.

2. The method of claim 1, wherein the display object is a graphic object, or wherein the 3D scene is a 3D still image, the displayable objects are image objects and the display object is a graphic box or a text box, or wherein the 3D scene is a 3D video image, the displayable objects are video objects and the display object is a timed graphic box or a timed text box, and wherein the display object and/or the displayable objects are two-dimensional (2D) or 3D objects.

3. The method of claim 1, wherein the display plane is a plane determined by a display surface of a device for displaying the 3D scene.

4. The method of claim 1, wherein providing the display distance of the one or more displayable objects comprises determining a depth map and calculating the display distance from the depth map.

5. The method of claim 1, wherein providing the display position comprises providing the display distance of the display object such that the display object is perceived to be as close or closer to a viewer than any other displayable object of the 3D scene when displayed together with the 3D scene.

6. The method of claim 1, wherein providing the display position comprises providing the display distance of the display object such that the display distance of the display object is equal to or greater than the display distance of any other displayable object positioned on the same side of the display plane as the display object.

7. The method of claim 1, wherein providing the display position of the display object comprises:
determining the display distance of the display position of the display object as being greater than or equal to the display distance of the displayable object which has the closest distance to the viewer among the plurality of displayable objects in the 3D scene; or
determining the display distance of the display position of the display object as being a difference, in particular a percentage of a difference, between the display distance of the displayable object which has the farthest distance to the viewer among the plurality of displayable objects in the 3D scene and another displayable object which has the closest distance to the viewer among the displayable objects in the same 3D scene; or
determining the display distance of the display position of the display object as being at least one corner display position of the display object, the corner display position being greater than or equal to the display distance, in particular the display distance of the displayable object which has the closest distance to the viewer among the plurality of displayable objects in the 3D scene.

8. The method of claim 1, wherein the method comprises determining the display position of the display object such that the display object is displayed in front of a certain displayable object comprised in the 3D scene, wherein providing the display distance of one or more displayable objects comprised in the 3D scene with respect to the display plane comprises providing the display distance of the certain displayable object, and wherein providing the display position comprising the display distance of the display object in dependence on the display distance of the one or more displayable objects in the same 3D scene comprises providing the display distance of the display object in dependence on the display distance of the certain displayable object.

9. The method of claim 1, further comprising transmitting the display position of the display object together with the display object over a communication network, or storing the display position of the display object together with the display object.

10. The method of claim 1, wherein the display position of the display object is determined for a certain 3D scene, and wherein another display position of the display object is determined for another 3D scene.

11. A method for displaying a display object together with a three-dimensional (3D) scene that comprises one or more displayable objects, the method comprising:
receiving the 3D scene;
receiving a display position of the display object comprising a display distance of the display object with respect to a display plane; and
displaying the display object at the received display position when displaying the 3D scene.

12. An apparatus configured to determine a display position of a display object to be displayed together with a three-dimensional (3D) scene, the apparatus comprising:
a processor,
wherein the processor is configured to:
provide a display distance of one or more displayable objects comprised in the 3D scene with respect to a display plane; and
provide the display position comprising a display distance of the display object in dependence on the display distance of the one or more displayable objects in the 3D scene.

13. The apparatus of claim 12, wherein the processor comprises a first provider for providing the display distance of one or more displayable objects with respect to the display plane, and a second provider for providing the display position of the display object in dependence on the display distance of the one or more displayable objects in the same 3D scene.

14. An apparatus for displaying a display object to be displayed together with a three-dimensional (3D) scene comprising one or more displayable objects, the apparatus comprising:
an interface for receiving the 3D scene comprising the one or more displayable objects, for receiving the display object, and for receiving a display position of the display object comprising a display distance of the display object with respect to a display plane; and
a display for displaying the display object at the received display position when displaying the 3D scene comprising the one or more displayable objects.

15. A non-transitory computer-readable medium having computer usable instructions stored thereon for execution by a processor, wherein the instructions cause the processor to perform a method for determining a display position of a display object to be displayed together with a three-dimensional (3D) scene, wherein the method comprises:
providing a display distance of one or more displayable objects comprised in the 3D scene with respect to a display plane; and
providing the display position comprising a display distance of the display object in dependence on the display distance of the one or more displayable objects in the 3D scene.
